(19) United States
(12) Patent Application Publication
(10) Pub. No.: US 2023/0286363 A1
(43) Pub. Date: Sep. 14, 2023

(54) SYSTEM AND METHOD FOR PROVIDING A PROTECTIVE SOFT COVER FOR THE SIDES AND TAILGATE OF A TRUCK BED

(71) Applicant: Jose H. Madrid, Taylorsville, UT (US)

(72) Inventor: Jose H. Madrid, Taylorsville, UT (US)

(21) Appl. No.: 18/183,144

(22) Filed: Mar. 13, 2023

Related U.S. Application Data
(60) Provisional application No. 63/319,231, filed on Mar. 11, 2022.

(51) Int. Cl. B60J 11/06

(52) U.S. Cl. CPC B60J 11/06

(57) ABSTRACT

The present invention is a system and method for providing protection for the outer sides and the tailgate of a pickup truck bed, wherein the external side protector panel includes three panels, a right side, a left side, and a connection panel between them, wherein the connection panel includes an elastic panel to provide added force to keep the external side protector panel flush to the external sides of a pickup truck bed to thereby prevent contaminants from getting between the side panels of the truck bed and the external side protector panel, and wherein a separate tailgate panel provides protection to the tailgate of the truck bed.

### BACKGROUND

Field of the Invention: This invention relates generally to a soft cover for the bed of a pickup truck. More specifically, the invention creates advantageous functionality for the soft cover in the form of a protective covering for the sides and tailgate of the bed of the pickup truck.

Description of Related Art: The prior art is replete with examples of different protective coverings for use in the bed of a pickup truck. These structures are typically used to protect the internal structure of the pickup truck such as the sidewalls and the floor of the pickup bed.

Only a few of the protective structures are designed for protection of the outer sides of the pickup truck bed. The prior art appears to teach that there are several issues with protecting the outside and tailgate.

A first issue that arises is that the protection may cause scratching of the paint. The scratches may arise as the protective cover is not held tightly, Movement of the protective cover then causes more issues than it is likely to solve.

A second issue may be that the protective cover is difficult to attach. A third issue may be that the protective cover is not able to be flexible in its attachment to the pickup bed.

Accordingly, it would be an advantage over the prior art to provide a protective structure that protects the outer sides and the tailgate of a pickup truck bed that is flexible, is flush against the pickup bed surfaces and is easy to attach.

### BRIEF SUMMARY

The present invention is a system and method for providing protection for the outer sides and the tailgate of a pickup truck bed, wherein the external side protector panel includes three panels, a right side, a left side, and a connection panel between them, wherein the connection panel includes an elastic panel to provide added force to keep the external side protector panel flush to the external sides of a pickup truck bed to thereby prevent contaminants from getting between the side panels of the truck bed and the external side protector panel, and wherein a separate tailgate panel provides protection to the tailgate of the truck bed.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of an external side protector panel.

FIG. 2A is a profile view of a portion of the external side protector panel with an integral hook.

FIG. 2B is a top view of a strap and buckle attachment mechanism.

FIG. 3 is a profile view of the left external side protector panel.

FIG. 4A is a profile view of a right external side protector panel, a left external side protector panel, and a connector panel in between.

FIG. 4B is a profile view of a tailgate panel.

FIG. 5 is a close-up profile view of a portion of the tailgate panel.

FIG. 6 is close-up profile view of the entire tailgate panel.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

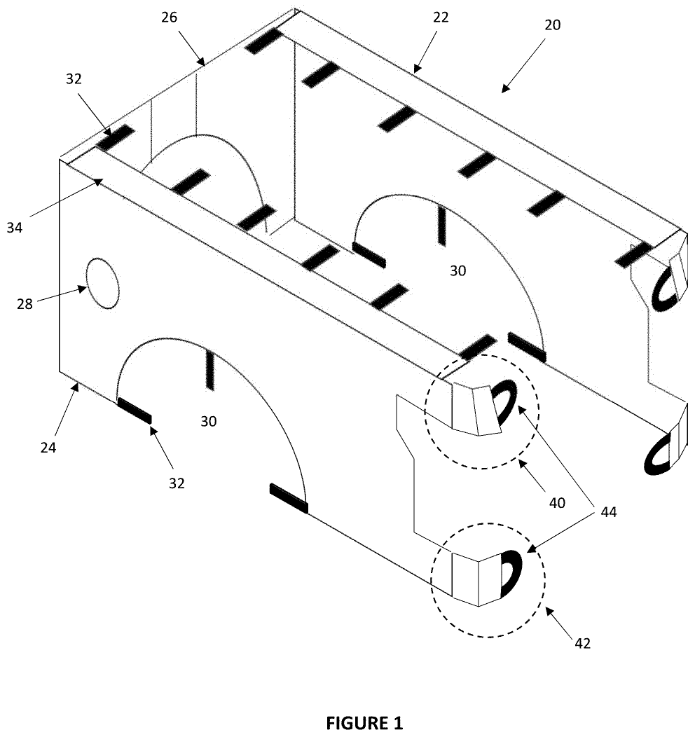

FIG. 1 is a perspective view of a portion of first embodiment of the invention. This first portion is a pickup truck bed external side protector panel 20. The external side protector panel 20 may be comprised of three panels. The three panels may be a right external side protector panel 22, a left external side protector panel 24, and a connecting panel 26.

The right external side protector panel 22 and the left external side protector panel 24 may be mirror images of each other and connected by the connecting panel 26. There may also be differences between the right external side protector panel 22 and the left external side protector panel 24.

A first difference is that the left external side protector panel 22 may include an access port 28 for a gas tank access panel. The shape of the access port 28 may be modified to match the shape of the gas tank access panel. The access port 28 may be opened by any temporary access mechanism. For example, the access port may include a zipper, or it may include hook and loop. What is important is that the access port 28 may be closed to prevent wind from getting under the left external side protector panel 22 and causing it to lift away from the external side of the truck bed.

It should be understood that the access port 28 may be disposed in the right external side protector panel 22 if the gas tank access panel is on the right side of the pickup truck.

Both the right external side protector panel 22 and the left external side protector panel 24 include a wheel well cutaway portion 30. The wheel well cutaway portion may be modified in size to fit the wheel well of any pickup truck.

The right external side protector panel 22 and the left external side protector panel 24 are attached to the pickup truck bed using a plurality of straps and hooks 32. The straps and hooks 32 are disposed on a top edge 34 of the right external side protector panel 22 and the left external side protector panel 24. The top edge 34 is an extended flap of the external side protector panel 20 that is disposed over a top edge of the pickup truck bed on both the right side and left side of the truck bed.

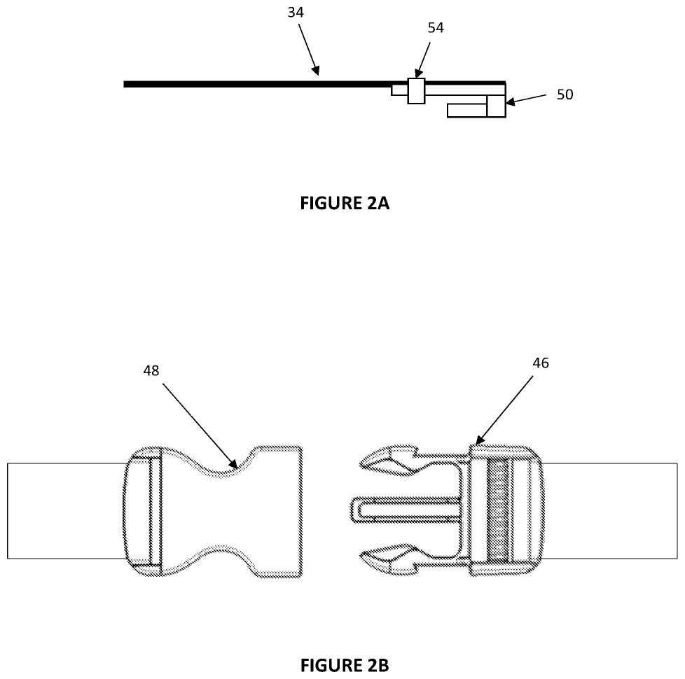

The straps and hooks 32 may also be replaced by a hook 50 as shown in FIG. 2A. The hook 50 may be mounted flush with an edge of the top edge 34. For example, the hook 50 may be attached to the top edge using a rivet attachment 54 or it may be sewn to the top edge 34. The use of a strap and hook 32 or just a hook 50 depends on the pickup truck bed.

One particular feature of the top edge 34 is that it prevents air from getting between the external side protector panel 20 and the external sides of the pickup truck bed. Specifically, an underside 36 (not shown) of the top edge 34 may include a hook and loop strip. The hook and loop strip may be attached to a corresponding hook and loop strip on a corresponding top edge of the pickup truck bed railing.

Experimentation showed that without the hook and loop strip, entry of air could be a problem that would prevent the external side protector panel from preventing dirt and other contaminants from getting underneath it and scratching the external sides of the pickup truck bed.

Another advantage of the use of the hook and loop strips is that it prevents movement of the external side protector panel 20. Preventing movement of the external side protector panel 20 eliminates scratching of the pickup truck bed paint if contaminants do get underneath it.

The external side protector panel 20 also includes a rear lights cutaway portion 38 at a rear of the truck bed. The shape of the rear lights cutaway portion 38 may be modified so as to match the rear lights of any pickup truck.

Another useful feature of the external side protector panel 20 is that at the top and rear portion as shown by dotted circle 40, the external side protector panel 20 is formed so as to be flush against the pickup truck bed as the external side protector panel moves around a rounded corner of the pickup truck bed. This corner is different from the bottom and rear portion as shown by dotted circle 42. The difference is that while the top and rear corner of the pickup truck bed is rounded, the bottom and rear portion is flat. Thus, the external side protector panel 20 may be modified to be flush with rounded corners and flat corners.

Another feature of the first embodiment shown in FIG. 1 is also shown in the dotted circle 40 and 42. Specifically, the attachment mechanism of the external side protector panel 20 may be provided by an elastic loop 44. The elastic loop 44 is disposed around a bolt (not shown) on the rear of the truck bed. The bolt typically extends from the rear of the truck bed as part of a latch mechanism for a tailgate.

The elastic loop 44 on the right side external side protector panel 22 and on the left side external side protector panel 24 may be used to cause a counteracting or opposing pulling force against the elastic panel 52 on the connection panel 26. This counteracting force is critical to holding the external side protector panels flush against the external surfaces of the pickup truck bed.

It should be understood that the elastic loop 44 may be replaced by a strap 46 and buckle 48 mechanisms as shown in FIG. 2B and as is understood by those skilled in the art. In the strap 46 and buckle 48 mechanisms, the strap and the buckle mechanisms extend away from the external side protector panel 20 and buckle together. Thus, if a bolt is not readily available, the strap 46 may be threaded through any structure of the pickup truck bed at the tailgate and then be coupled to the buckle 48.

The wheel well cutaway portion 30 may also include a plurality of straps and hooks 32. It is more likely that a strap will be needed so that the straps and hooks 32 may reach under a wheel well of the pickup truck and reach an edge that can be hooked to the straps and hooks. The number and the length of straps and hooks 32 may vary according to the specific design of the bed of the pickup truck and should not be considered to be a limiting factor of the embodiments of the invention.

A final feature of the first embodiment shown in FIG. 1 is the connecting panel 26.

Experimentation demonstrated that while straps and hooks are useful, it is difficult to secure the external side protector panel 20 such that air does not get underneath it and allow contaminants to get between the external sides of the pickup truck bed and the underside of the external side protector panel.

Accordingly, a modification to the connecting panel 26 may substantially reduce the ability of air to lift the external side protector panel 20. The modification is the insertion of an elastic panel 52 into the connecting panel 26.

As shown in FIG. 1, the connecting panel 26 may include two features. The first feature is a large connecting panel cutaway portion 54 that resembles a wheel well cutaway portion 30. The function of the connecting panel cutaway portion 54 is to allow the right external side protector panel 22 and the left external side protector panel 24 to be connected and thereby form a single unit that does not require hooks or straps where the external side protector panel meets a cab of the pickup truck.

The second function of the connecting panel 26 is to increase tension on the elastic loops 44 that attach the external side protector panel 20 to the back of the pickup truck bed. By increasing tension, experimentation has shown that the external side protector panel 20 maintains a flush position against the external sides of the pickup truck bed by preventing air from lifting the external side protector panel.

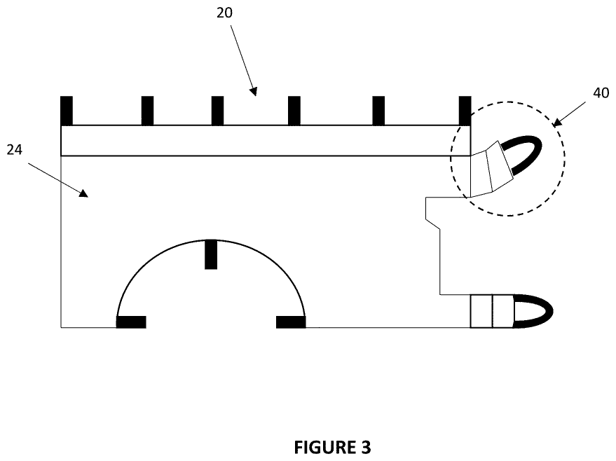

FIG. 3 is a profile view of the left external side protector panel 24 of the external side protector panel 20 when it is laid flat. It should be understood that the left external side protector panel 24 is still coupled on a left edge to the connecting panel 26. This view illustrates the curvature in the top rear portion as indicated by the dotted circle 40 that enables the external side protector panel 20 to stay flush with a curved corner of the pickup truck bed. This curvature in the external side protector panel 20 may be removed of the pickup truck bed does not have a rounded corner.

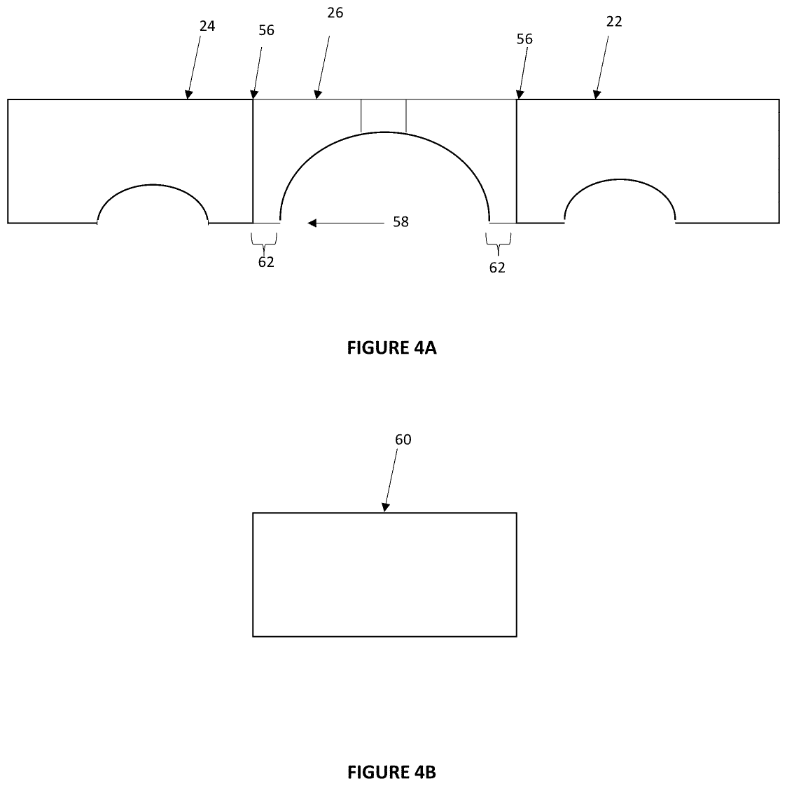

FIG. 4A is profile view of the external side protector panel 20 shown with all of the panels connected. Thus, FIG. 4A shows the right external side protector panel 22, the connecting panel 26 with the elastic panel 52, and the left external side protector panel 24. It is noted that the right external side protector panel 22 and the left external side protector panel 24 do not show the connection mechanisms that connect to the end of the pickup truck bed. This view is provided to illustrate how the three panels 22, 24, 26, appear when laid out flat.

An important feature of the three panels 22, 24, 26 is that a seam 56 is disposed between the panels and illustrates where the three panels 22, 24, 26, make a 90 degree angle. It should be apparent from the placement of the seams 56 that a portion of the connection panel 26 goes to a bottom 58 of the three panels 22, 24, 26. Furthermore, it should also be seen that a portion 62 of the center panel 26 extends behind the cab of the pickup truck. Experimentation showed that these two features combined to prevent air from getting under the external side protector panel 20.

FIG. 4B is a profile view of the tailgate panel 60. It is approximately the same dimensions as the connection panel 26.

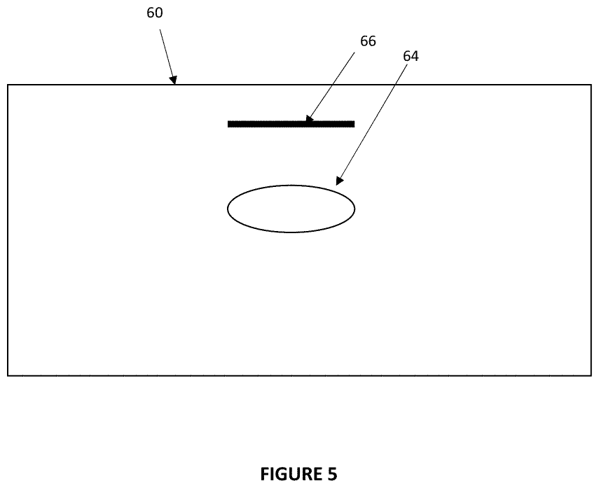

FIG. 5 is a close-up profile view of a portion of the tailgate panel 60. This view shows that there may be a tailgate cut-out 64. The precise location of the tailgate cutout 64 may vary. The function of the tailgate cut-out 64 is to allow the display of a vehicle logo that is typically disposed on a tailgate.

FIG. 5 also shows a tailgate access seam 66. The tailgate access seam 66 may be disposed where a tailgate handle (not shown) is typically disposed on a tailgate. The driver may unseal a hook and look closure or unzip a zipper at the tailgate seam 66 to enable access to the tailgate handle.

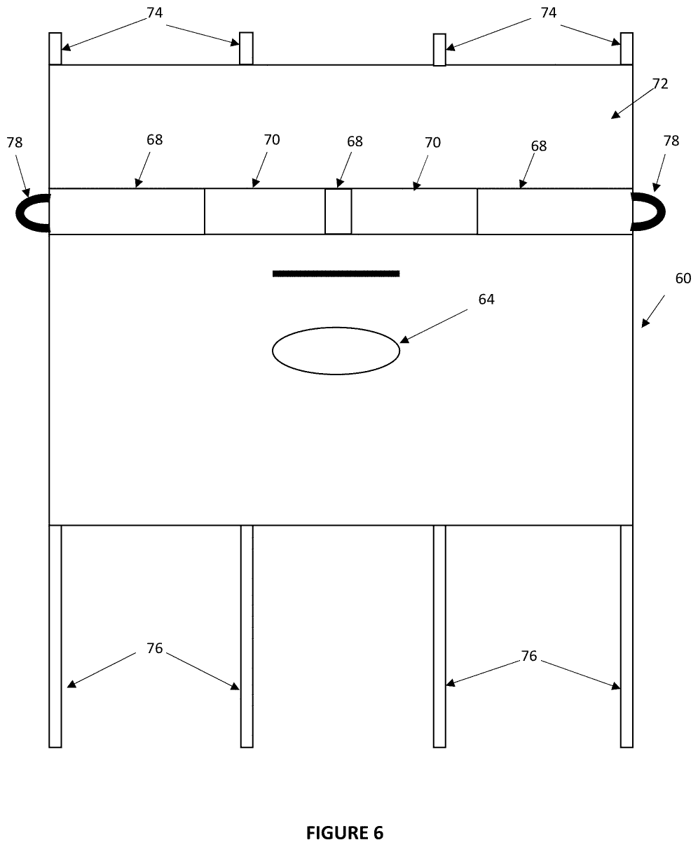

FIG. 6 is a profile view of all of the tailgate panel 60, including a portion that is inside the pickup truck bed. The tailgate panel 60 includes the tailgate cut-out 64 and the tailgate access seam 66. Now visible features include some top tailgate portions 68 that may be interspersed with top tailgate cut-outs 70. The top tailgate cut-outs 70 may be used to access tailgate controls that may only be accessible from a top of the tailgate.

The tailgate panel 60 may also include an inside tailgate panel 72. Attached to the inside tailgate panel 72 may be a plurality of buckles 74. These buckles 74 may be coupled with a plurality of corresponding straps 76 that may go underneath the tailgate to thereby hold the tailgate panel 60 in place.

Another feature of the first embodiment of the tailgate panel 60 may be to include two elastic loops 74, one on each side of the tailgate panel. The elastic loops may be folded down on each side of the top tailgate portions 68 and function to hold the tailgate panel 60 in place.

It is noted that advertising or other visual designs may be disposed on an outside of the external side protector panel 60 to enable removable advertising.

The external side protector panel 20 may provide a means for protecting the sides of the bed of the pickup truck from rocks, dirt and other debris that may damage the vehicle. Accordingly, the external side protector panel 20 may be comprised of a waterproof or water-resistant material. This enables the external side protector panel 20 to repel water, dirt and other contaminants, but also enables the external side protector panel to be easily cleaned.

In summary, the first embodiment may be described as an external side protector panel for providing protection from contaminants that scratch an external surface of a pickup truck bed, the external side protector panel comprised of a right external side protector panel disposed on an outside surface of the external surface of the pickup truck bed and coupled to the pickup truck bed using a plurality of straps and hooks, a left external side protector panel disposed on an outside surface of the external surface of the pickup truck bed and coupled to the pickup truck bed using a plurality of straps and hooks, a connection panel coupled between the right external side protector panel and the left external side protector panel, and an elastic panel disposed in the connection panel that applies a force to the left external side protector panel and the right external side protector panel to hold them flush against the external surface of the pickup truck bed.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. An external side protector panel for providing protection from contaminants that scratch an external surface of a pickup truck bed, the external side protector panel comprised of:
a right external side protector panel disposed on an outside surface of the external surface of the pickup truck bed and coupled to the pickup truck bed using a plurality of straps and hooks;
a left external side protector panel disposed on an outside surface of the external surface of the pickup truck bed and coupled to the pickup truck bed using a plurality of straps and hooks;
a connection panel coupled between the right external side protector panel and the left external side protector panel; and
an elastic panel disposed in the connection panel that applies a force to the left external side protector panel and the right external side protector panel to hold them flush against the external surface of the pickup truck bed.
